(19) United States
(12) Patent Application Publication
(10) Pub. No.: US 2016/0353325 A1
(43) Pub. Date: Dec. 1, 2016

(54) LOAD BALANCED GATEWAY SELECTION IN LTE COMMUNICATIONS

(71) Applicant: NOKIA SOLUTIONS AND NETWORKS OY, Espoo (FI)

(72) Inventor: Henri Mikael POIKONEN, Helsinki (FI)

(21) Appl. No.: 15/116,702

(22) PCT Filed: Feb. 5, 2014
(86) PCT No.: PCT/EP2014/052179

§ 371 Date: Aug. 4, 2016

(51) Int. Cl. H04W 28/08; H04W 24/02; H04L 12/24

(52) U.S. Cl. CPC H04W 28/08; H04L 41/0246; H04L 41/0816; H04W 24/02; H04W 88/16

(57) ABSTRACT

A method is disclosed for selecting a gateway node in a LTE communications system for balancing the load among the gateway nodes (e. g., P-GW, S-GW), and comprising modifying a mobility management entity, MME, local configuration based on load statistics information; and selecting a gateway node (PGW1, PGW2, PGW3) based on the modified mobility management entity local configuration. Said modifying being effected using an application programming interface (e. g. REST/JSON API) and comprising one or more of: adding a gateway node to the local configuration, removing a gateway node from the local configuration, and updating additional gateway node information in the local configuration.

### FIELD OF THE INVENTION

The exemplary and non-limiting embodiments of this invention relate generally to wireless communications networks, and more particularly to gateway selection.

### BACKGROUND ART

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

Representational state transfer (REST) is an architectural style containing a coordinated set of constraints applied to components, connectors, and data elements, within a distributed hypermedia system. REST may be applied to describe desired web architecture, to identify existing problems, to compare alternative solutions, and/or to ensure that protocol extensions do not violate core constraints that make the web successful. A concept in REST is the existence of resources (sources of specific information), each of which is referenced with a global identifier (e.g. URI in HTTP). In order to manipulate these resources, components of the network (user agents and origin servers) communicate via a standardized interface (e.g. HTTP) and exchange representations of these resources (the actual documents conveying the information). For example, a resource that represents a circle (as a logical object) may accept and return a representation that specifies a center point and radius, formatted in SVG, but may also accept and return a representation that specifies any three distinct points along the curve (since this also uniquely identifies a circle) as a comma-separated list. Any number of connectors (e.g. clients, servers, caches, tunnels, etc.) may mediate the request, but each does so without “seeing past” its own request (referred to as “layering”, another constraint of REST and a common principle in many other parts of information and networking architecture). Thus, an application may interact with a resource by knowing two things: the identifier of the resource and the action required. The application does not need to know whether there are caches, proxies, gateways, firewalls, tunnels, or anything else between the application and the server actually holding the information. The application does, however, need to understand the format of the information (representation) returned, which is typically an HTML, XML, or JSON document of some kind, although it may be an image, plain text, or any other content.

JSON, or JavaScript object notation, is an open standard format that uses human-readable text to transmit data objects consisting of attribute-value pairs. JSON is primarily used to transmit data between a server and web application, as an alternative to XML. Although originally derived from the JavaScript scripting language, JSON is a language-independent data format, and code for parsing and generating JSON data is readily available in a large variety of programming languages.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, apparatus, and a computer program product as defined in the independent claims. Further embodiments of the invention are disclosed in the dependent claims.

An aspect of the invention relates to a method for selecting a gateway node in a communications system, wherein the method comprises modifying, in a network apparatus, a mobility management entity local configuration; and selecting a gateway node for a user terminal based on a modified mobility management entity local configuration; said modifying comprising one or more of: adding a gateway node to the local configuration by using an application programming interface, removing a gateway node from the local configuration by using the application programming interface, and updating additional gateway node information in the local configuration by using the application programming interface.

A further aspect of the invention relates to an apparatus comprising at least one processor; and at least one memory including a computer program code, wherein the at least one memory and the computer program code are configured to, with the at least one processor, cause the apparatus to modify a mobility management entity local configuration; and select a gateway node for a user terminal based on a modified mobility management entity local configuration; wherein the modifying of the mobility management entity local configuration comprises one or more of: adding a gateway node to the local configuration by using an application programming interface, removing a gateway node from the local configuration by using the application programming interface, and updating additional gateway node information in the local configuration by using the application programming interface.

A still further aspect of the invention relates to a computer program product comprising executable code that when executed, causes execution of functions of modifying, in a network apparatus, a mobility management entity local configuration; and selecting a gateway node for a user terminal based on a modified mobility management entity local configuration; said modifying comprising one or more of: adding a gateway node to the local configuration by using an application programming interface, removing a gateway node from the local configuration by using the application programming interface, and updating additional gateway node information in the local configuration by using the application programming interface.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 illustrates adding a new gateway to a configuration;

FIG. 2 illustrates updating gateway loads to a mobility management entity;

FIG. 3 shows a simplified block diagram illustrating an exemplary system architecture;

FIG. 4 shows a messaging diagram illustrating an exemplary messaging event according to an embodiment of the invention;

FIG. 5 shows a schematic diagram of a flow chart according to an exemplary embodiment of the invention.

### DETAILED DESCRIPTION OF SOME EMBODIMENTS

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

Currently, SGW/PGW selection in MME is relying on records received from a DNS server. The SGW selection depends on TAI in which UE is currently camping, and PGW is selected based on an APN requested. MME forms FQDN from TAI to query SGWs from the DNS server. For PGWs MME forms APN-FQDN. Based on DNS responses it is possible to perform semi-static load-balancing between GWs. However, DNS weights are not meant for dynamic server selection. It requires very short TTLs for the DNS records limiting usefulness of DNS caching mechanism, thus increasing overall network load and decreasing overall reliability. The DNS server responds to queries of available network elements from MME. Data received in MME is statically stored, and therefore no dynamic picture of available network elements, e.g. SGWs and PGWs, is updated.

An exemplary embodiment enables improving the SGW/PGW selection in MME. An exemplary embodiment provides more automated and dynamic GW selection in MME by utilizing MME REST/JSON APIs. In an exemplary embodiment, NMS (or other applications such GW itself) may use API to automatically modify GW selection principles in MME. It may be possible to perform at least following functionalities with APIs: adding GW to an MME local configuration; removing GW from the MME local configuration; updating/modifying GW information such as load statistics, served APNs/TAIs, availability etc.

REST/JSON APIs may be used by different web services (Amazon web services, Facebook, Twitter, Dropbox) to allow access to their data and services. It is also possible to use similar APIs for the MME configuration, so that other applications may have access to the MME configuration and also modify parameters.

An exemplary embodiment enables optimizing and automating the GW selection in MME. An exemplary embodiment enables an automated GW configuration in MME as well as providing/updating actual GW load statistics and additional information for influencing the selection. An exemplary embodiment also proposes that GW availability information may be updated to MME. MME may use the GW availability information to optimize the GW selection for UE. An exemplary embodiment proposes/assumes that MME exposes the GW configuration to other applications with programmable APIs. In an exemplary embodiment, REST/JSON APIs may be used, but APIs may be accomplished by using other notations as well.

In an exemplary configuration, the information provided in API calls may include at least following information: TAIs served by GW (in case a node is acting as SGW) and/or APNs served by GW (in case GW is acting as PGW); a GW node name, and IP address(es) of relevant interface(s), e.g. S11 and S8.

In addition to “mandatory” information, it may also be possible to provide updates on a GW load status to enhance the GW selection in MME based on an actual load status. The information provided to MME may also include other relevant data to improve the GW selection, e.g. a set of subscribers/groups that may be served by GW that may have its own GW for higher QoS. Additionally, it may be possible to update the GW availability information to MMEs.

The load statistics provided to MME may include e.g. following information: a simple number describing a relative load of GW, similar to a weight field in DNS SRV records (this may be provided e.g. by NMS which may know the load status of each GW); more advanced load statistics from each GW, such as 1) CPU load information and/or information on bearer amounts (may also be a relative number, e.g. 50% of the bearers are allocated); also information on the amount of available IP addresses may be provided (for PGWs); 2) the load information may also be provided on a more detailed level such as per APN to allow more accurate GW selection in MME. For example, PGWs may have separate IP address pools for each APN and MME and may take it into account when choosing GW for UE.

Applications (e.g. NMS) may be able to update the GW availability information to MMEs. For example, if GW is unavailable e.g. due to a failure, MME may then ignore said GW from the GW selection as long as said GW is unavailable. This may be useful at least for PGW, since MME does not have a direct connection to PGW. MME may only be able to get PGW related error causes from SGW or a notification that PGW has restarted.

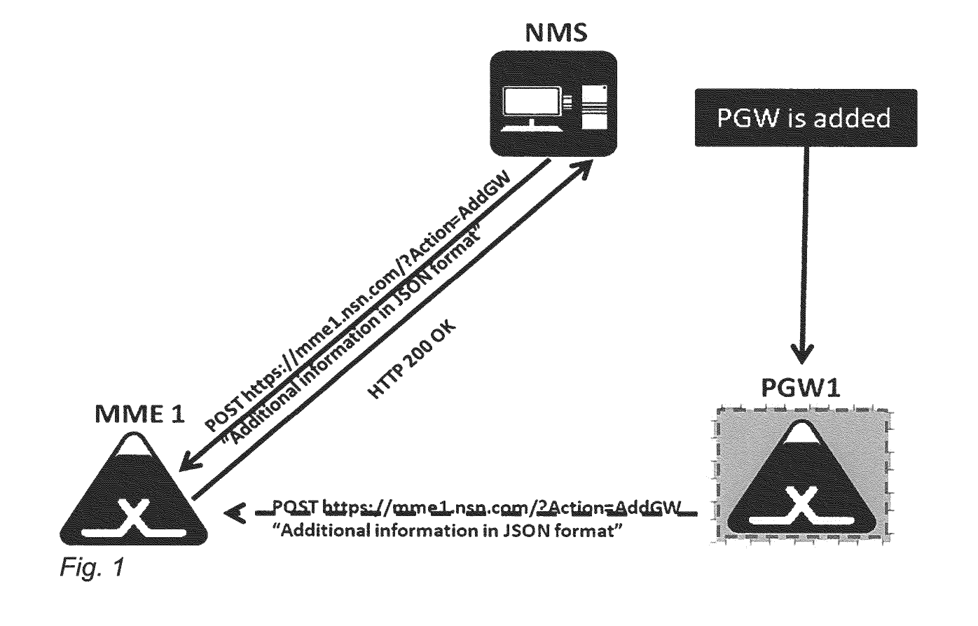

FIG. 1 illustrates adding a new GW to the configuration. FIG. 1 shows an example on how the API call for adding the new GW may look like. After MME has received the request, MME may update the new GW to MME local configuration and acknowledge it to a requesting entity.

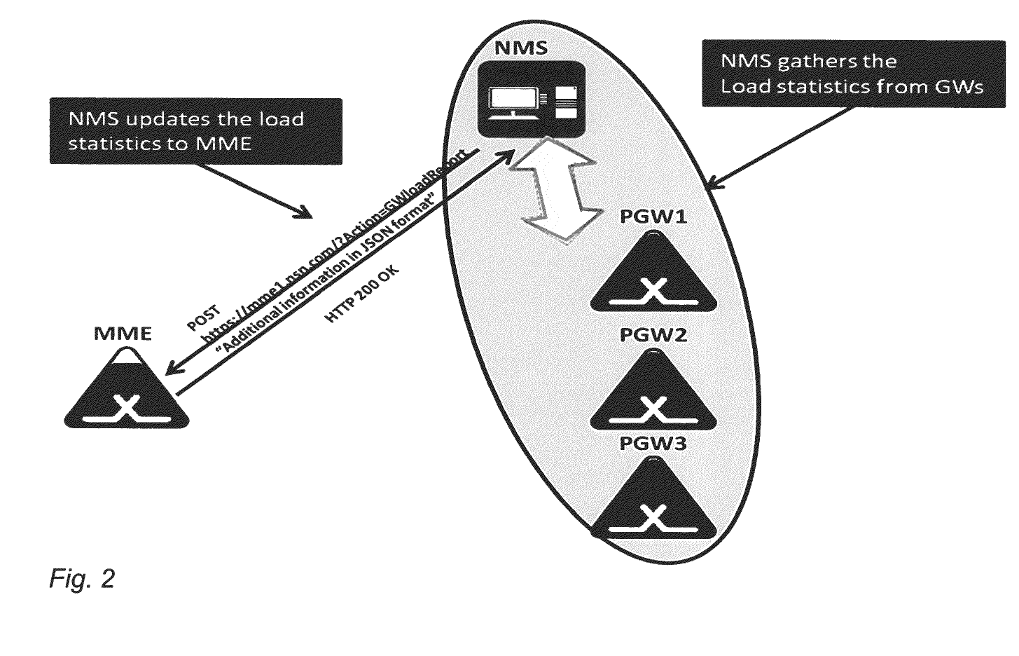

FIG. 2 illustrates updating GW loads to MME. FIG. 2 shows an example on how NMS may be able to update the GW load information to MMEs. NMS gathers the load statistics from GWs and updates the information to MME. A load report may include different types of load information as described above. Optionally, each GW may update its own load information to MMEs separately.

The local configuration does not completely replace a DNS based selection but complements it. An operator may use the local configuration for a subset of GWs and still use the DNS based selection for the rest. For example, for roamers the PGW selection in home routed traffic cases may use the DNS selection. And since the configuration may also include a SGW/PGW node name, MME may use it to make collocation and topological closeness selections for SGW and PGW similar to the DNS case. The operator may also limit the local GW configuration only to selected groups of subscribers.

Another option may involve that MME gets a list of SGWs/PGW names for TAI/APN from the DNS server as specified, and the list may include more detailed information on SGW/PGWs configured locally.

The local GW selection may affect the GW selection in MME for the following procedures: attach; PDN connectivity request; handover with SGW relocation (including inter-RAT handover).

During the GW selection, MME may apply the local GW configuration based on operator preference. E.g. the local configuration has a higher priority than the DNS selection, i.e. the local configuration is checked first or vice versa. In the GW selection, MME may take into account the load information updated to MME. An actual selection algorithm may depend on the operator preference and available load information, For example if relative weight information is provided, MME may apply load balancing similar to that used with SRV records (as described in RFC 2782). Or if the selection is based on the bearers or available IP addresses (for APN), MME may select GW with the highest amount of free IP addresses or bearers.

The MME logic may also include protection against a GW overload situation. For example, MME may have threshold values for the GW load information and if a threshold is reached, MME does not take that GW into account in the selection as long as the load is above the threshold value.

An exemplary embodiment enables the operator to optimize and automate a GW selection process for UE in MME. GW configuration changes in MMEs may be automated, since the applications (NMS/GW/3rd party applications) may have access to the GW configuration in MME. The automated configuration benefits the operator by reducing an amount of manual configuration work, thus reducing the workload for operating personnel.

An exemplary embodiment enables an optimized GW selection with accurate load information. The load information may be frequently updated to MME so that the GW selection is based on the actual load levels of GWs instead of relying on semi-static load balancing information. The more accurate information helps to protect GWs from an overload situation, and the GW selection in MME is able to react to rapid changes in the GW load status.

An exemplary embodiment enables an advanced GW selection based on “additional information”. In addition to the load information, MME may have more criteria for selecting GW for UE. The additional information may include, for example, groups (e.g. MTC devices) or IMSI ranges that GW is serving. Or for SGW selection, the additional information may include more accurate information on the location to enable selecting the closest SGW to eNB.

In an exemplary embodiment, by means of the overload and/or availability information for GWs, MME may reduce traffic towards the overloaded GW or automatically bypass the unavailable GW in the selection process.

Thus, an exemplary embodiment enables GW selection optimization in MME using REST/JSON APIs.

An exemplary embodiment enables providing MME with a centralized database that dynamically stores current availability data of different cloud based network elements such as SGWs and PGWs. The information on available network elements, e.g. SGWs and PGWs, is pushed from O&M, i.e. from NMS, through a regular O&M interface of MME.

An exemplary embodiment enables updating load/overload information to MME. However a GTP-C mechanism (GTP-C overload specified in 3GPP TS 23.401) may also be used (instead of/in addition to a REST/JSON based load update) to update the load information to MME.

An exemplary embodiment enables automatic SGW/PGW configuration to MME (by NMS/CAM or 3rd party applications) so that e.g. in cloud environment the configuration is able to follow dynamic scaling (i.e. GWs are added/removed based on the load/traffic).

For example, if existing GW resources are not enough and a new GW instance is needed/created, the new GW instance may automatically be updated to relevant MMEs.

An exemplary embodiment enables updating additional criteria (other than the load information) to affect the GW selection. The information may comprise anything from more accurate location information in the SGW selection to assigning certain groups to use certain GWs. And compared to a current DNS based solution, it may be easier to provide a separate configuration to MMEs based e.g. on a geographical area.

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, server, corresponding component, and/or to any communication system or any combination of different communication systems that support gateway node selection. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE-A network elements, without restricting the embodiment to such an architecture, however. The embodiments described in these examples are not limited to the LTE-A systems but can also be implemented in other network systems, such as UMTS (universal mobile telecommunications system), LTE, LTE-A, GSM, EDGE, WCDMA, bluetooth network, WLAN or other fixed, mobile or wireless network. In an embodiment, the presented solution may be applied between elements belonging to different but compatible systems such as LAN, WLAN, LTE, LTE-A and UMTS.

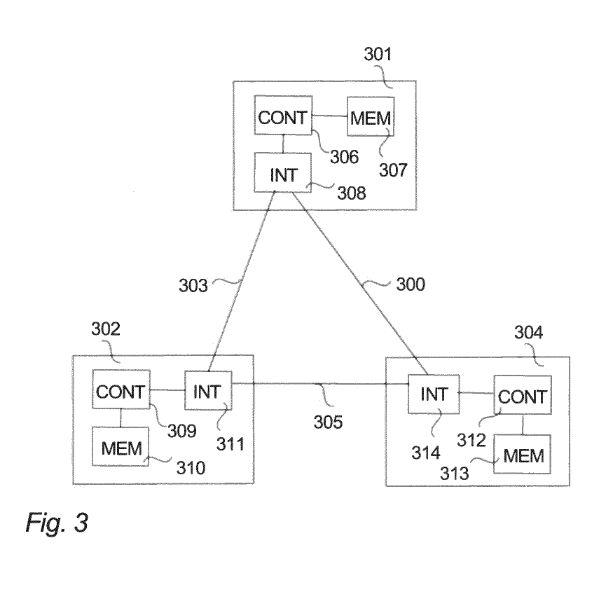

A general architecture of a communication system is illustrated in FIG. 3. FIG. 3 is a simplified system architecture only showing some elements and functional entities, all being logical units whose implementation may differ from what is shown. The connections shown in FIG. 3 are logical connections; the actual physical connections may be different. It is apparent to a person skilled in the art that the systems also comprise other functions and structures. It should be appreciated that the functions, structures, elements and the protocols used in or for gateway selection, are irrelevant to the actual invention. Therefore, they need not to be discussed in more detail here.

The exemplary network system of FIG. 3 comprises a network element 301 of a network service provider. The network element 301 may include e.g. mobility management entity MME, or any other network element, or a combination of network elements, or a component/subset of a network element. The network node 301 may be connected to a network element 302 such as a network management system NMS via a connection 303. FIG. 3 shows one or more gateway nodes 304 such as a PDN gateway PGW connected to the mobility management entity 301 via a connection 300 and to the network management system 302 via a connection 305. The network node 301, 302, 304 may be connected to one or more core network (CN) elements (not shown in FIG. 3) such as a mobile switching centre (MSC), MSC server (MSS), serving gateway (SGW), gateway GPRS support node (GGSN), serving GPRS support node (SGSN), home location register (HLR), home subscriber server (HSS), visitor location register (VLR), a related mediator element, or to one or more radio network elements (not shown in FIG. 3) such as a base station (of e.g. LTE/LTE-A, 3G/HPSA, 2G or WLAN), to a radio network controller (e.g. 3G RNC, 2G BSC, or WLAN controller), or to a combination of network elements.

The mobility management entity MME 301 comprises a controller 306 operationally connected to a memory 307. The controller 201 controls the operation of the SDN controller 301. The memory 307 is configured to store software and data. The mobility management entity MME 301 may be operationally connected (directly or indirectly) to another network element or to another component/subset of a network element of the communication system, such as the network management system NMS 302 or the gateway node 304, via an interface 308.

The network management system NMS 302 comprises a controller 309 operationally connected to a memory 310. The controller 201 controls the operation of the network management system NMS 302. The memory 310 is configured to store software and data. The network management system NMS 302 may be operationally connected (directly or indirectly) to another network element or to another component/subset of a network element of the communication system, such as the mobility management entity MME 301 or the gateway node 304, via an interface 311.

The gateway node 304 comprises a controller 312 operationally connected to a memory 313. The controller 312 controls the operation of the gateway node 304. The memory 313 is configured to store software and data. The gateway node 304 may be operationally connected (directly or indirectly) to another network element or to another component/subset of a network element of the communication system, such as the mobility management entity MME 301 or the network management system NMS 302, via an interface 314.

The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 301, 302, 304 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 301, 302, 304 may generally include a processor, controller, control unit or the like connected to a memory and to various inter-faces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 307, 310, 313 may include volatile and/or non-volatile memory and typically stores content, data, or the like. For example, the memory 307, 310, 313 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

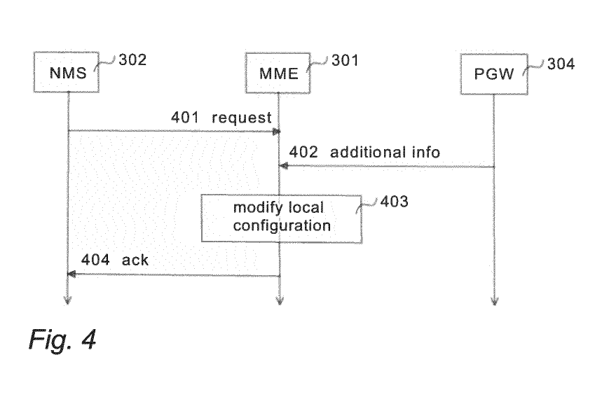

The signalling chart of FIG. 4 illustrates the required signalling. In the example of FIG. 4, in item 401, a request to add and/or remove a gateway node to/from a local configuration of a mobility management entity MME 301 may be transmitted from a network management system NMS 302 to the mobility management entity MME 301. In item 402, additional gateway information, such as gateway load statistics information, may be transmitted from a gateway node PGW 304 to the mobility management entity MME 301. In item 403, the mobility management entity MME 301 may modify the local configuration of the mobility management entity MME 301 based on the information received in items 401 and/or 402. In item 404, the mobility management entity MME 301 may transmit, to the network management system NMS 302, an acknowledgement on the modification of the local configuration of the mobility management entity MME 301. The mobility management entity MME 301 may perform 403 gateway selection based on the modified local configuration. The modifying may comprise adding a gateway node to the local configuration by using an application programming interface, removing a gateway node from the local configuration by using the application programming interface, and/or updating additional gateway node information in the local configuration by using the application programming interface.

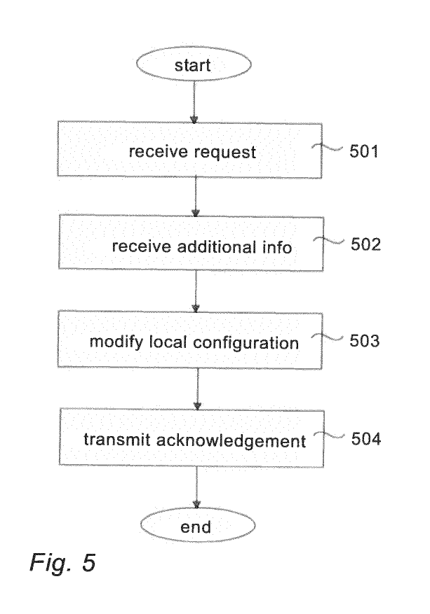

FIG. 5 is a flow chart illustrating an exemplary embodiment. In FIG. 5, in item 501, a request to add and/or remove a gateway node to/from a local configuration of a mobility management entity MME 301 may be received in the mobility management entity MME 301 from a network management system NMS 302. In item 502, additional gateway information, such as gateway load statistics information, may be received in the mobility management entity MME 301 from a gateway node PGW 304. In item 503, the mobility management entity MME 301 may modify the local configuration of the mobility management entity MME 301 based on the information received in items 501 and/or 502. In item 504, the mobility management entity MME 301 may transmit, to the network management system NMS 302, an acknowledgement on the modification of the local configuration of the mobility management entity MME 301. The mobility management entity MME 301 may perform 504 gateway selection based on the modified local configuration. The modifying may comprise adding a gateway node to the local configuration by using an application programming interface, removing a gateway node from the local configuration by using the application programming interface, and/or updating additional gateway node information in the local configuration by using the application programming interface.

The steps/points, signalling messages and related functions de-scribed above in FIGS. 1 to 4 are in no absolute chronological order, and some of the steps/points may be performed simultaneously or in an order differing from the given one. Other functions can also be executed between the steps/points or within the steps/points and other signalling messages sent be-tween the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

NMS network management system

MME mobility management entity

REST representational state transfer

API application programming interface

JSON JavaScript object notation

UE user equipment

TAI tracking area identity

SGW serving gateway

PGW PDN gateway

PDN packet data network/public data network

FQDN fully qualified domain name

APN access point name

GW gateway

TTL time to live

DNS domain name system

PDN packet data network

MTC machine type communication

IMSI international mobile subscriber identity

CPU central processing unit

GTP-C GPRS tunnelling protocol-control plane

CAM content addressable memory

1-28. (canceled)

29. A method for selecting a gateway node in a communications system, wherein the method comprises
modifying, in a network apparatus, a mobility management entity local configuration; and
selecting a gateway node for a user terminal based on a modified mobility management entity local configuration;
said modifying comprising one or more of
adding a gateway node to the local configuration by using an application programming interface,
removing a gateway node from the local configuration by using the application programming interface, and
updating additional gateway node information in the local configuration by using the application programming interface, wherein the additional gateway node information comprises at least one of gateway node load statistics information, information on served access point names/tracking area identities, and gateway node availability information, wherein the additional gateway node information is received from at least one of a network management system and the gateway node.

30. A method according to claim 29, the method comprising one or more of
using a REST/JSON application programming interface or some other notation for providing the application programming interface; and
exposing the local configuration to at least one of a network management system and other applications with programmable application programming interfaces.

31. A method as claimed in claim 29, wherein information provided in application programming interface calls comprises information on one or more of:
tracking area identities served by the gateway node in case the gateway node is acting as a serving gateway,
access point names served by the gateway node in case the gateway node is acting as a packet data gateway, and
a gateway node name and an IP address of a relevant interface.

32. A method as claimed in claim 29, wherein gateway node load statistics information comprises one or more of
information on a relative load of the gateway node,
CPU load information,
information on bearer amounts,
information on the amount of available IP addresses, and
access point name specific load information.

33. A method as claimed in claim 29, the method comprising
modifying the local configuration in response to receiving a corresponding request; and
acknowledging the modification of the local configuration to a requesting entity.

34. A method as claimed in claim 33, the method comprising
the requesting entity being a network management system.

35. A method as claimed in claim 29, the method comprising
modifying the local configuration in response to receiving the additional gateway node information.

36. A method as claimed in claim 29, the method comprising
during the gateway node selection, prioritizing the local configuration over DNS selection.

37. A method as claimed in claim 29, the method comprising
maintaining a threshold value for gateway node load information, wherein if the threshold value is reached for a specific gateway node, said specific gateway node is disregarded during the gateway node selection as long as the load is above the threshold value.

38. An apparatus comprising at least one processor; and at least one memory including a computer program code, wherein the at least one memory and the computer program code are configured to, with the at least one processor, cause the apparatus to
modify a mobility management entity local configuration; and
select a gateway node for a user terminal based on a modified mobility management entity local configuration;
wherein the modifying of the mobility management entity local configuration comprises one or more of
adding a gateway node to the local configuration by using an application programming interface,
removing a gateway node from the local configuration by using the application programming interface, and
updating additional gateway node information in the local configuration by using the application programming interface, wherein the additional gateway node information comprises at least one of gateway node load statistics information, information on served access point names/tracking area identities, and gateway node availability information,
wherein the at least one memory and the computer program code are configured to, with the at least one processor, cause the apparatus to receive the additional gateway node information from at least one of a network management system and the gateway node.

39. An apparatus according to claim 38, wherein the at least one memory and the computer program code are configured to, with the at least one processor, cause the apparatus to use a REST/JSON application programming interface or some other notation for providing the application programming interface.

40. An apparatus as claimed in claim 38, wherein the at least one memory and the computer program code are configured to, with the at least one processor, cause the apparatus to expose the local configuration to at least one of a network management system and other applications with programmable application programming interfaces.

41. An apparatus as claimed in claim 38, wherein information provided in application programming interface calls comprises information on one or more of:
tracking area identities served by the gateway node in case the gateway node is acting as a serving gateway,
access point names served by the gateway node in case the gateway node is acting as a packet data gateway, and
a gateway node name and an IP address of a relevant interface.

42. An apparatus as claimed in claim 38, wherein gateway node load statistics information comprises one or more of
information on a relative load of the gateway node,
CPU load information,
information on bearer amounts,
information on the amount of available IP addresses, and
access point name specific load information.

43. An apparatus as claimed in claim 38, wherein the at least one memory and the computer program code are configured to, with the at least one processor, cause the apparatus to
modify the local configuration in response to receiving a corresponding request; and
acknowledge the modification of the local configuration to a requesting entity.

44. An apparatus as claimed in claim 43, wherein the requesting entity is a network management system.

45. An apparatus as claimed in claim 38, wherein the at least one memory and the computer program code are configured to, with the at least one processor, cause the apparatus to
modify the local configuration in response to receiving the additional information.

46. An apparatus as claimed in claim 38, wherein the at least one memory and the computer program code are configured to, with the at least one processor, cause the apparatus to
during the gateway node selection, prioritize the local configuration over DNS selection.

47. An apparatus as claimed in claim 38, wherein the at least one memory and the computer program code are configured to, with the at least one processor, cause the apparatus to
maintain a threshold value for gateway node load information, wherein if the threshold value is reached for a specific gateway node, said specific gateway node is disregarded during the gateway node selection as long as the load is above the threshold value.

48. A computer program product embodied on a non-transitory computer-readable medium, said product comprising executable code that when executed, causes execution of functions of
modifying, in a network apparatus, a mobility management entity local configuration; and
selecting a gateway node for a user terminal based on a modified mobility management entity local configuration;
said modifying comprising one or more of
adding a gateway node to the local configuration by using an application programming interface,
removing a gateway node from the local configuration by using the application programming interface, and
updating additional gateway node information in the local configuration by using the application programming interface, wherein the additional gateway node information comprises at least one of gateway node load statistics information, information on served access point names/tracking area identities, and gateway node availability information, wherein the additional gateway node information is received from at least one of a network management system and the gateway node.
